(19) United States
(12) Patent Application Publication
(10) Pub. No.: US 2020/0053644 A1
(43) Pub. Date: Feb. 13, 2020

(54) METHOD FOR POWER SAVING AND POWER SAVING CIRCUIT FOR A MOBILE DEVICE

(71) Applicant: Intel IP Corporation, Santa Clara, CA (US)

(72) Inventors: Matthias Obermeier, Taufkirchen (DE); Zijian Bai, Neubiberg (DE); Sven Dortmund, Essen (DE); Matthias Hofmann, Freital (DE)

(21) Appl. No.: 15/738,449

(22) PCT Filed: May 23, 2016
(86) PCT No.: PCT/EP2016/061596

§ 371 Date: Mar. 16, 2018

(30) Foreign Application Priority Data
Jun. 26, 2015 (DE) 102015110330.3

(51) Int. Cl. H04W 52/02; H04W 76/28

(52) U.S. Cl. CPC H04W 52/0229; H04W 76/28; H04W 52/028

(57) ABSTRACT

A method (200) for power saving in a radio receiver receiving a sequence of radio subframes includes: monitoring (204) information from at least one first section of at least one radio subframe in the sequence of radio subframes; and if the information indicates an absence (205) of user data in at least one second section of a threshold number of successive sequence of radio subframes, changing (203) to a first state (202) in which receiving of the at least one second section is switched-off.

### FIELD

The disclosure relates to a method for power saving in a radio receiver and a power saving circuit for a mobile device. In particular, the disclosure relates to techniques for substantial power saving in connected mode, in particular LTE connected mode with low to medium throughput.

### BACKGROUND

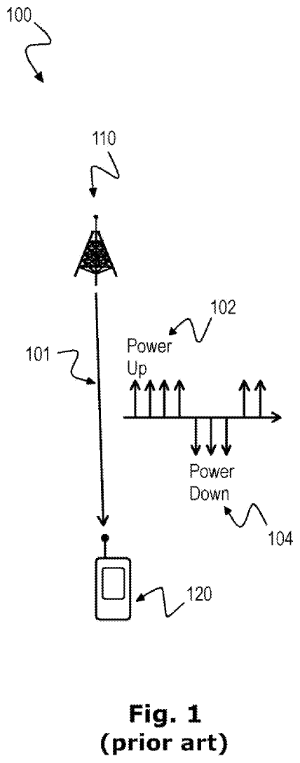

In a conventional radio communication system 100, e.g. as illustrated in FIG. 1 downlink transmission 101 from radio cell 110 to mobile station 120 may include information regarding power control of the mobile station. A power up command 102 may signal the mobile station 120 to change in normal power mode while a power down command 104 may signal the mobile station 120 to change in power saving mode. However, latencies for decoding the power up and power down commands 102, 104, signaling and shutting down the receive path decrease the power saving performance. There is a need to improve power saving performance in the mobile device.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following

### DETAILED DESCRIPTION

FIG. 1 is a schematic diagram illustrating a conventional radio communication system 100.

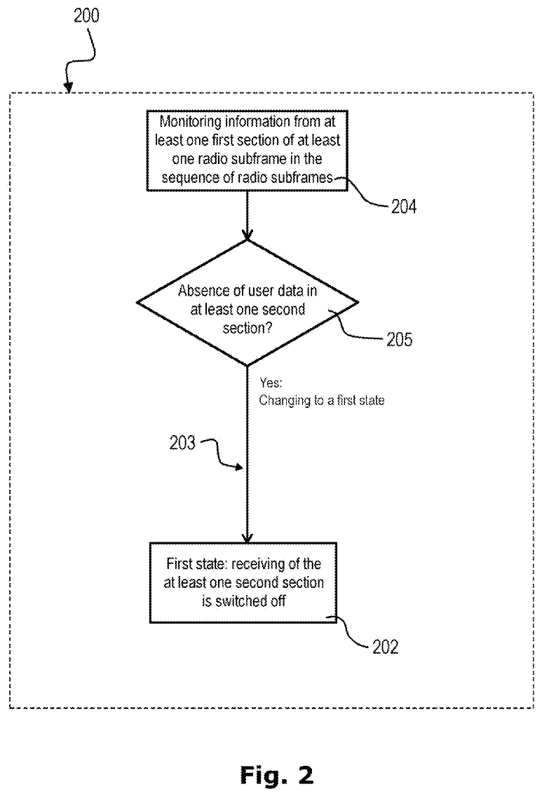

FIG. 2 schematically illustrates an exemplary method 200 for power saving in a radio receiver.

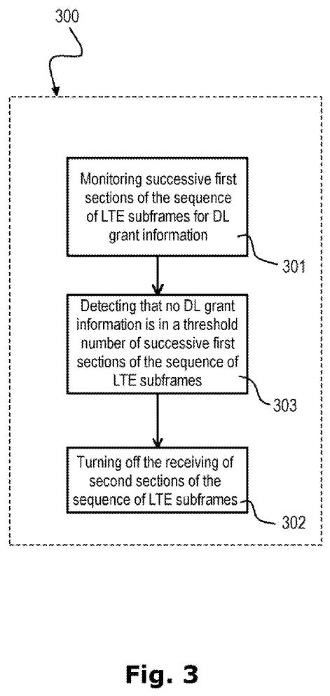

FIG. 3 schematically illustrates an exemplary method 300 for power saving in an LTE radio receiver.

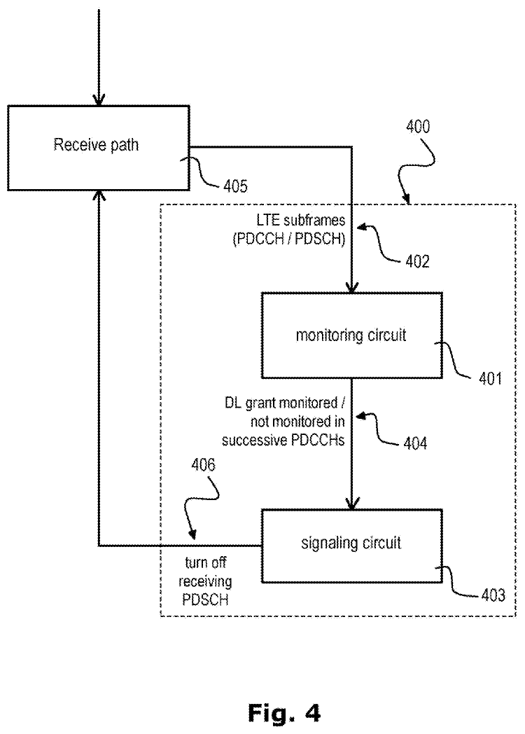

FIG. 4 schematically illustrates an exemplary power saving circuit 400.

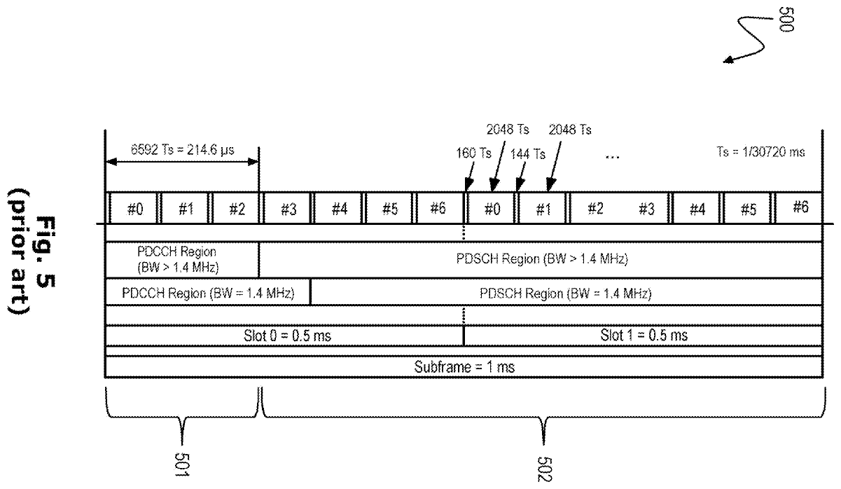

FIG. 5 illustrates a timing of a basic LTE subframe 500 according to a conventional LTE standard.

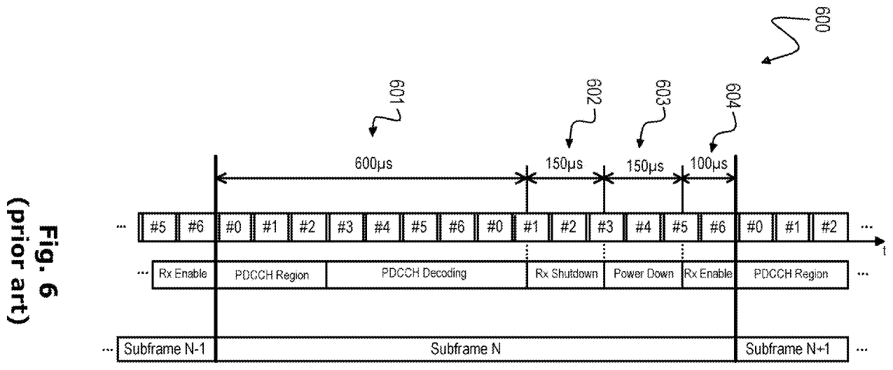

FIG. 6 illustrates the LTE subframe timing 600 for dynamic switching of the Rx chain according to a conventional LTE standard.

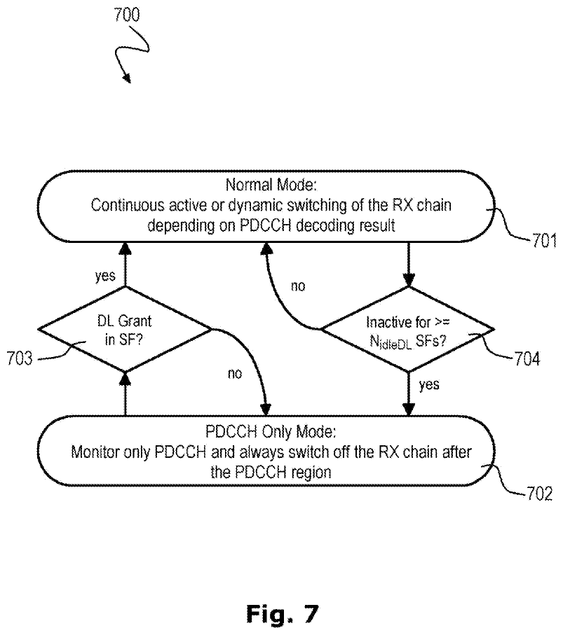

FIG. 7 is a basic state diagram 700 for entering and leaving PDCCH Only Mode.

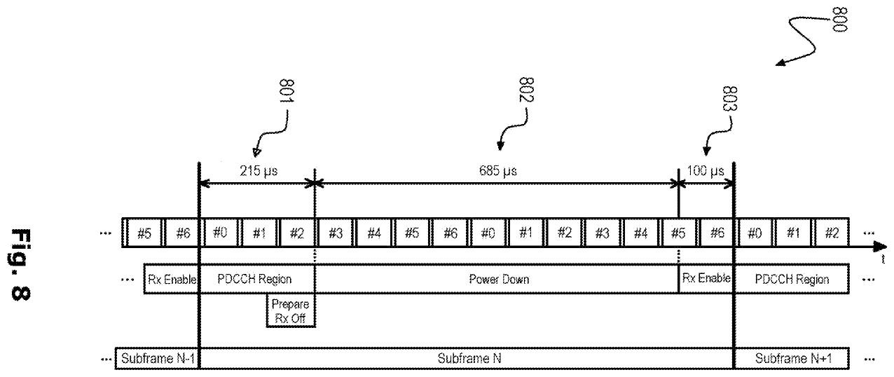

FIG. 8 is a timing diagram of an LTE subframe 800 illustrating the LTE subframe timing for PDCCH Only Mode 702 according to FIG. 7.

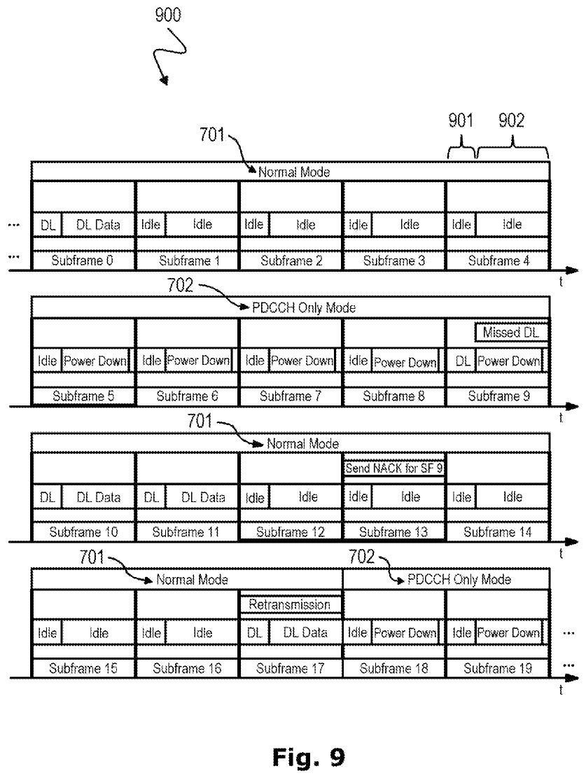

FIG. 9 is an exemplary timing diagram 900 illustrating the switching between Normal Mode 701 and PDCCH Only Mode 702 according to FIG. 7 with an exemplary value of N_{idleDL}=4.

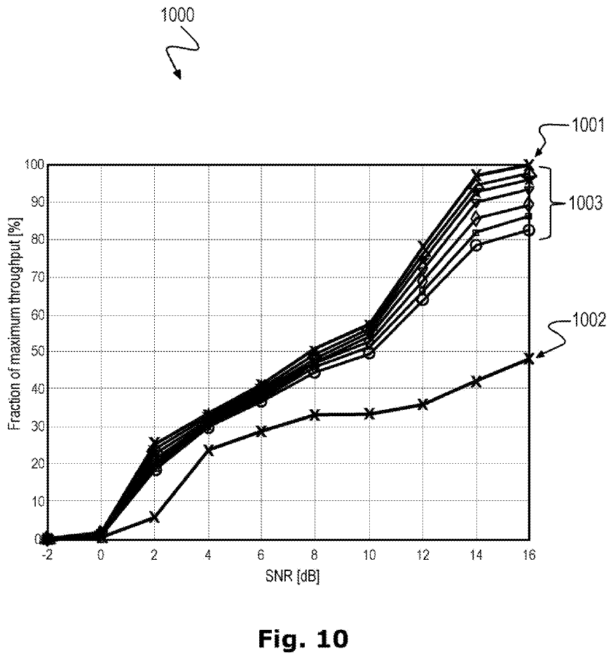

FIG. 10 is an exemplary performance diagram 1000 illustrating throughput impact of PDCCH Only Mode when using a simple traffic model.

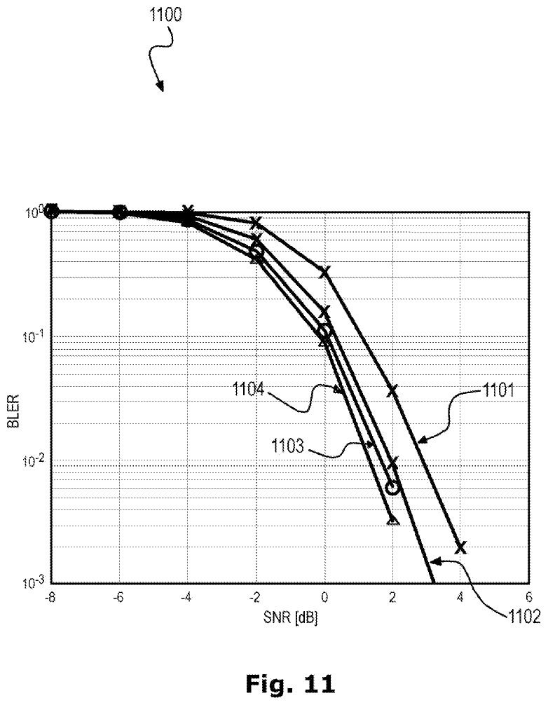

FIG. 11 is an exemplary performance diagram 1100 illustrating PDCCH decoding with channel estimation on different number of CRS symbols.

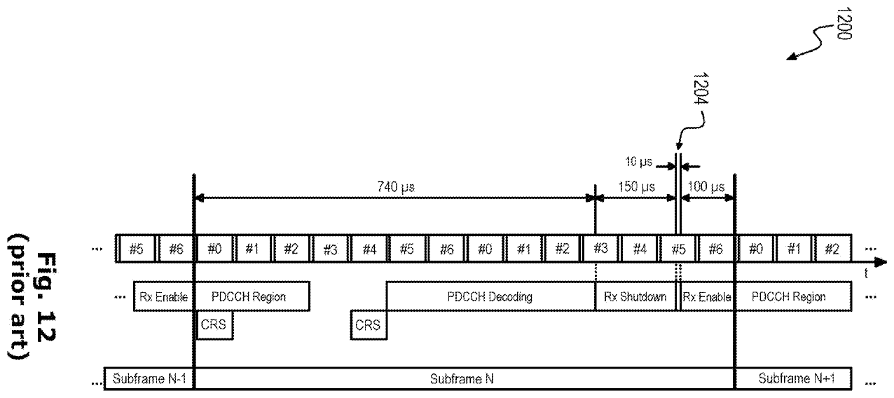

FIG. 12 is an exemplary timing diagram 1200 illustrating dynamic switching of the RX chain with two CRS symbols for PDCCH channel estimation according to a conventional LTE standard.

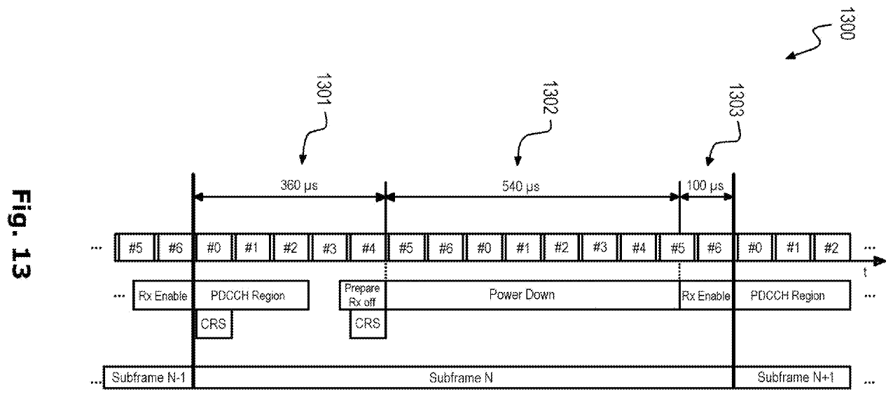

FIG. 13 is an exemplary timing diagram 1300 for PDCCH Only Mode with two CRS symbols for PDCCH channel estimation.

### DETAILED DESCRIPTION

In the following detailed description, reference is made to the accompanying drawings, which form a part thereof, and in which is shown by way of illustration specific aspects in which the invention may be practiced. It is understood that other aspects may be utilized and structural or logical changes may be made without departing from the scope of the present invention. The following detailed description, therefore, is not to be taken in a limiting sense, and the scope of the present invention is defined by the appended claims.

The following terms, abbreviations and notations will be used herein:
CRS: Cell specific Reference Signal,
RE: Resource Element,
RB: Resource Block, e.g., a resource block in frequency direction times slot in time direction,
PRB: Physical Resource Block,
3GPP: 3rd Generation Partnership Project,
LTE: Long Term Evolution,
LTE-A: LTE Advanced, Release 10 and higher versions of 3GPP LTE,
RF: Radio Frequency,
UE: User Equipment,
SINR: Signal-to-interference and noise ratio,
OFDM: Orthogonal Frequency Division Multiplex, eNB,
eNodeB: Base station,
(e)ICIC: (enhanced) Inter-Cell Interference Coordination,
MIMO: Multiple Input Multiple Output,
CE: Channel Estimation,
HARQ: Hybrid Automatic Repeat Request,
PDCCH: Physical Downlink Control Channel,
DL: Downlink,
BW: Bandwidth,
DCI: Downlink Control Information,
PDSCH: Physical Downlink Shared Channel,
CA Carrier aggregation,
DRX: Discontinuous receive,
CDRX: Connected mode DRX.

The methods and devices described herein may be based on power saving and power saving circuits in mobile devices and radio receivers, in particular LTE radio receivers. It is understood that comments made in connection with a described method may also hold true for a corresponding device configured to perform the method and vice versa. For example, if a specific method step is described, a corresponding device may include a unit to perform the described method step, even if such a unit is not explicitly described or illustrated in the figures. Further, it is understood that the features of the various exemplary aspects described herein may be combined with each other, unless specifically noted otherwise.

The methods and devices described herein may be implemented in wireless communication networks, in particular communication networks based on mobile communication standards such as LTE, in particular LTE-A and/or OFDM. The methods and devices described below may be implemented in mobile devices (or mobile stations or User Equipments (UE)), in particular in radio receivers of such mobile devices. The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

The methods and devices described herein may be configured to transmit and/or receive radio signals. Radio signals may be or may include radio frequency signals radiated by a radio transmitting device (or radio transmitter or sender) with a radio frequency lying in a range of about 3 Hz to 300 GHz. The frequency range may correspond to frequencies of alternating current electrical signals used to produce and detect radio waves.

The methods and devices described herein after may be designed in accordance to mobile communication standards such as e.g. the Long Term Evolution (LTE) standard or the advanced version LTE-A thereof. LTE (Long Term Evolution), marketed as 4G LTE, is a standard for wireless communication of high-speed data for mobile phones and data terminals.

The methods and devices described hereinafter may be applied in OFDM systems. OFDM is a scheme for encoding digital data on multiple carrier frequencies. A large number of closely spaced orthogonal sub-carrier signals may be used to carry data. Due to the orthogonality of the sub-carriers crosstalk between sub-carriers may be suppressed.

The methods and devices described hereinafter may be applied in multi-layer heterogeneous networks. Multi-layer heterogeneous networks (HetNet) may be used in LTE and LTE-Advanced standards to build up the network of not only a single type of eNodeB (homogeneous network), but to deploy eNodeBs with different capabilities, most importantly different Tx-power classes.

The methods and devices described hereinafter may be applied in eICIC systems. ICIC based on Carrier Aggregation may enable an LTE-A UE to connect to several carriers simultaneously. It not only may allow resource allocation across carriers, it also may allow scheduler based fast switching between carriers without time consuming handover.

The methods and devices described hereinafter may be applied in MIMO systems and diversity receivers. Multiple-input multiple-output (MIMO) wireless communication systems employ multiple antennas at the transmitter and/or at the receiver to increase system capacity and to achieve better quality of service. In spatial multiplexing mode, MIMO systems may reach higher peak data rates without increasing the bandwidth of the system by transmitting multiple data streams in parallel in the same frequency band. A diversity receiver uses two or more antennas to improve the quality and reliability of a wireless link.

In the following, embodiments are described with reference to the drawings, wherein like reference numerals are generally utilized to refer to like elements throughout. In the following description, for purposes of explanation, numerous specific details are set forth in order to provide a thorough understanding of one or more aspects of embodiments. However, it may be evident to a person skilled in the art that one or more aspects of the embodiments may be practiced with a lesser degree of these specific details. The following description is therefore not to be taken in a limiting sense.

The various aspects summarized may be embodied in various forms. The following description shows by way of illustration various combinations and configurations in which the aspects may be practiced. It is understood that the described aspects and/or embodiments are merely examples, and that other aspects and/or embodiments may be utilized and structural and functional modifications may be made without departing from the scope of the present disclosure.

FIG. 2 schematically illustrates an exemplary method 200 for power saving in a radio receiver which is receiving a sequence of radio subframes. Each radio subframe may includes a first section carrying control data and a successively arranged second section.

The method 200 includes monitoring 204 information from at least one first section of at least one radio subframe in the sequence of radio subframes; and if the information indicates an absence 205 of user data in at least one second section of a threshold number of successive sequence of radio subframes, changing 203 to a first state 202 in which receiving of the at least one second section is switched-off.

The method may include: monitoring 204 information from the at least one first section of a given radio subframe in the sequence of radio subframes and received after the at least one radio subframe; if the monitored information indicates a presence of user data in the at least one second section of the given radio subframe, changing from the first state 202 to a second state in which receiving of the at least one second section of the sequence of radio subframes is activated.

The at least one first section and the at least one second section may be successively arranged in each radio subframe. In the second state receiving of the at least one first section of the sequence of radio subframes may be turned-on to monitor information indicating a presence of user data in the corresponding at least one second section. In the first state 202 receiving of the at least one second section of the sequence of radio subframes may be turned-off. The method 200 may include changing from the second state to the first state 202 if no retransmission of a radio subframe is pending. The method 200 may include delaying the changing to the first state 202 depending on a number of pending retransmissions of the sequence of radio subframes. The method 200 may include reporting a failed reception of the given radio subframe which at least one first section caused a change from the first state 202 to the second state. The method 200 may include initiating a retransmission of the given radio subframe which at least one first section caused a change from the first state 202 to the second state 201.

In the following, an exemplary implementation of the method 200 is described. The method 200 may include an act of monitoring 204 information from a number of successive first sections of the sequence of radio subframes. The method 200 may further include an act of changing 203 from a first state 202 in which the receiving of the second section of the sequence of radio subframes is activated to a second state in which the receiving of the second section of the sequence of radio subframes is switched-off, if the monitored information indicates an absence 205 of user data in the corresponding second sections, wherein the changing 203 is based on a transition from the first section to the second section of the sequence of radio subframes.

The changing 203 may be performed in response to the transition from the first section to the second section of the sequence of radio subframes. The changing 203 may be performed after the transition from the first section to the second section. The changing 203 may be performed shortly before the transition from the first section to the second section. The changing 203 may be performed shortly after the transition from the first section to the second section. Shortly means here a short time interval compared to the time of the whole first section or second section. The changing 203 may be performed after a preparation section at the end of the first section. The changing 203 may be performed after a preparation section at the beginning of the second section.

The method 200 may further include an act of changing from the second state to the first state 202 if information monitored from a first section of the sequence of radio subframes indicates a presence of user data in the corresponding second section. The method 200 may further include an act of changing 203 from the first state 202 to the second state or vice versa when receiving the next radio subframe after the information indicating the absence 205 or the presence of user data is monitored. The method 200 may further include an act of changing 203 from the first state 202 to the second state if in each first section of the number of successive first sections the monitored information indicates an absence (205) of user data in the corresponding second sections. The method 200 may further include an act of changing from the second state to the first state 202 if in a single first section of the sequence of radio subframes information is monitored indicating a presence of user data in the corresponding second section.

In the second state the receiving of the first sections of the sequence of radio frames may be turned-on to monitor information indicating a presence of user data in the corresponding second sections.

In the second state the receiving of the second sections of the sequence of radio subframes may be turned-off responsive to a transition from a respective first section to a corresponding second section of the radio subframe.

The method 200 may further include an act of changing from the first state 202 to the second state if no retransmission of a radio subframe is pending.

The method 200 may further include an act of delaying a changing from the first state 202 to the second state depending on a number of pending retransmissions of radio subframes.

The method 200 may further include an act of reporting a failed reception of the subframe which first section caused a change from the second state to the first state 202.

The method 200 may further include an act of initiating a retransmission of the subframe which first section caused a change from the second state to the first state 202.

FIG. 3 schematically illustrates an exemplary method 300 for power saving in an LTE radio receiver which is receiving a sequence of LTE subframes. Each LTE subframe may include a first section of PDCCH OFDM symbols followed by a corresponding second section of PDSCH OFDM symbols.

The method 300 includes: monitoring 301 successive first sections of the sequence of LTE subframes for DL grant information; detecting 303 that no DL grant information is in a threshold number of successive first sections of the sequence of LTE subframes; and in response to detecting that no DL grant information is in the threshold number of successive first sections of the sequence of LTE subframes, turning off 302 the receiving of second sections of the sequence of LTE subframes.

Each LTE subframe may include a first section of PDCCH OFDM symbols followed by a corresponding second section of PDSCH OFDM symbols. The method 300 may include: monitoring 301 the first sections of the sequence of LTE subframes for DL grant information while the receiving of the second sections of the sequence of LTE subframes is turned off; detecting DL grant information in the first section of a given LTE subframe; and in response to detecting DL grant information in the first second of the given LTE subframe, turning on the receiving of the second sections of the sequence of LTE subframes.

The method 300 may include turning-off 302 the receiving of the second sections of the sequence of LTE subframes if no retransmission of an LTE subframe is pending. The method 300 may include delaying the turning-off 302 of the receiving depending on a number of pending HARQ retransmissions of LTE subframes. The method 300 may include reporting a failed reception of the given LTE subframe. The method 300 may include initiating a retransmission of the given LTE subframe.

In the following, an exemplary implementation of the method 300 is described. The method 300 may include an act of monitoring 301 a number of successive first sections of the sequence of LTE subframes for DL grant information. The method may further include an act of turning-off 302 the receiving of the second sections of the sequence of LTE subframes if no DL grant information is detected in the number of successive first sections of the sequence of LTE subframes, wherein the turning-off 302 is responsive to a transition from a first section to a corresponding second section of the sequence of LTE subframes.

The method 300 may further include an act of monitoring 301 the first sections of the sequence of LTE subframes for DL grant information during the turning-off 302 of the receiving of the second sections of the sequence of LTE subframes; and turning-on the receiving of the second sections of the sequence of LTE subframes if the DL grant information is detected in a first section of the sequence of LTE subframes.

The method 300 may further include an act of turning-off 302 the receiving of the second sections of the sequence of LTE subframes if no retransmission of an LTE subframe is pending. The method 300 may further include an act of delaying the turning-off 302 of the receiving depending on a number of pending HARQ retransmissions of LTE subframes. The method 300 may further include an act of reporting a failed transmission of the LTE subframe which first section caused the turning-on of the receiving. The method 300 may further include an act of initiating a retransmission of the LTE subframe which first section caused the turning-on of the receiving.

FIG. 4 schematically illustrates an exemplary power saving circuit 400 for a mobile device.

The power saving circuit includes a monitoring circuit 401 and a signaling circuit 403. The monitoring circuit 401 is used for monitoring a received sequence of LTE subframes 402, wherein each LTE subframe comprises a first section of PDCCH OFDM symbols followed by a corresponding second section of PDSCH OFDM symbols. The monitoring circuit 401 is configured to monitor a number of successive first sections of the received sequence of LTE subframes for DL grant information 404. The signaling circuit 403 is configured to signal a receive path 405 to turn-off 406 receiving the second sections of the sequence of LTE subframes 402 if no DL grant information (404) is detected in the number of successive first sections of the sequence of LTE subframes 402. The turn-off 406 is responsive to a transition from a first section to a corresponding second section of the sequence of LTE subframes 402.

The monitoring circuit 401 may monitor the first sections of the sequence of LTE subframes 402 for DL grant information 404 when the receiving of the second sections of the sequence of LTE subframes 402 is turned-off 406 in the receive path 405. The signaling circuit 403 may signal the receive path 405 to turn-on receiving the second sections of the sequence of LTE subframes if the DL grant information 404 is detected in a first section of the sequence of LTE subframes 402.

The signaling circuit 403 may signal the receive path 405 to turn-off 406 receiving the second sections of the sequence of LTE subframes when the mobile device is in Radio Resource Control Connected mode.

The signaling circuit 403 may signal the receive path 405 to turn-off 406 receiving the second sections of the sequence of LTE subframes 402 when the mobile device is in CDRX.

The mobile device may be connected to a primary cell based on a first carrier and to one or more secondary cells based on one or more secondary carriers. The signaling circuit 403 may signal the receive path 405 to turn-off 406 receiving the second sections of the sequence of LTE subframes carrier-independently.

The mobile device may include an RX diversity receiver comprising the receive path and a second receive path. The signaling circuit 403 may signal the receive path 405 to turn-off 406 receiving the second sections of the sequence of LTE subframes 402 depending on information indicating an activity of the second receive path.

FIG. 4 also illustrates a power saving circuit 400 for a mobile device. Including: a monitoring circuit 401 for monitoring a received sequence of LTE subframes 402, wherein each LTE subframe comprises a first section of PDCCH OFDM symbols followed by a corresponding second section of PDSCH OFDM symbols, wherein the monitoring circuit 401 is configured to monitor a number of successive first sections of the received sequence of LTE subframes 402 for DL grant information 404; and a signaling circuit 403 configured to signal a receive path 405 to turn-off 406 receiving the second sections of the sequence of LTE subframes 402 if no DL grant information 404 is detected in the number of successive first sections of the sequence of LTE subframes 402. The the turn-off 406 may be responsive to one of the following conditions: a first condition is a transition from a first section to a corresponding second section of the sequence of LTE subframes 402, a second condition is a detection of a cell-specific reference symbol in the second section of the sequence of LTE subframes 402.

The signaling circuit 403 may use the first condition or the second condition depending on a SINR.

The power saving circuit 400 may implement one of the methods 200, 300 described above with respect to FIGS. 2 and 3.

FIG. 5 illustrates a timing of a basic LTE subframe 500 according to a conventional LTE standard. The LTE subframe 500 may be received as a radio subframe by the method 200 described above with respect to FIG. 2 or may be received as an LTE subframe by the method 300 described above with respect to FIG. 3. The LTE subframe 500 may be received by the monitoring circuit 401 as described above with respect to FIG. 4.

In LTE a 1 ms downlink radio subframe 500 consists of 14 OFDM symbols (with normal cyclic prefix). The PDCCH (Physical Downlink Control Channel) 501 is always transmitted in the first symbols of a DL subframe 500 and carries Downlink Control Information (DCI). The exact number of OFDM symbols carrying the PDCCH 501 is dynamically chosen by the eNodeB and is signaled in the PCFICH (Physical Control Format Indicator Channel). For cell bandwidth (BW)>=3 MHz it can be transmitted in the first up to 3 symbols; for BW=1.4 MHz in the first up to 4 symbols, respectively. The following, remaining symbols of the subframe contain the PDSCH (Physical Downlink Shared Channel) 502 which carries user data and higher layer control messages. Timing details can be seen in FIG. 5.

Every OFDM symbol has a duration of 2048 Ts and is preceded by a cyclic prefix. The cyclic prefix for the first OFDM symbol in a slot has a duration of 160 Ts, for all others the duration is 144 Ts.

The DCI on the PDCCH 501 includes DL grant information, i.e. whether there is data for the UE in the following PDSCH symbols 502 of the subframe 500 or not. The sequence of PDCCH 501 and PDSCH 502 was chosen intentionally to allow power saving on the UE side: if there is no DL grant on PDCCH 501 the Rx path can theoretically be turned off during the PDSCH region 502. This is of particular relevance in RRC (Radio Resource Control) connected state, where the UE has to continuously monitor the PDCCH 501, except for connected mode DRX (Discontinuous Receive).

The problem with this approach is the decoding latency of the PDCCH 501 on the baseband side plus the latency for signaling and shutting down the complete RX path (baseband and RF) as can be seen from FIG. 6.

FIG. 6 illustrates the LTE subframe timing 600 for dynamic switching of the Rx chain according to a conventional LTE standard, i.e. a switching without using a method 200, 300 or a device 400 described above with respect to FIGS. 2 to 4. FIG. 6 can be used as a reference timing diagram indicating a basic power saving performance. Methods 200, 300 and devices 400 according to the disclosure can be compared against this basic power saving performance in order to evaluate a power saving efficiency of these methods 200, 300 and devices 400.

Assuming a PDCCH configuration of 3 OFDM symbols the typical time to decode the PDCCH on the baseband side is around 600 us 601 after the subframe boundary in antenna timing plus about 150 us 602 for UE internal signaling of the decoding results and shutting down the entire RX chain. So the power will only be turned off about 750 us 601, 602 after the subframe boundary. Power needs to be turned on again before the start of the first PDCCH symbol in the next subframe, for which a lead time of about 100 us 604 can be assumed for PLL startup etc. Details are illustrated in the timing diagram in FIG. 6.

Overall this leaves only about 150 us power down time 603 which translates into a rather small power save impact: only ˜15% of the subframe in power down.

Methods 200, 300 and devices 400 according to the disclosure introduce a new operation mode that may be referred to as “PDCCH Only Mode” hereinafter, which targets to maximize the power down time in subframes without DL grants in order to minimize the power consumption in LTE connected mode. “PDCCH Only Mode” may correspond to the second state described above with respect to FIG. 2 or to the turning-off 302, 406 the receiving of the second sections of the sequence of LTE subframes 402 as described above with respect to FIGS. 3 and 4.

FIG. 7 is a basic state diagram 700 for entering and leaving PDCCH Only Mode 702.

Instead of dynamically switching the power of the RX chain during the PDSCH region depending on the PDCCH decoding result the idea is to switch to PDCCH Only Mode 702 under certain conditions, where the RX chain is always turned off after PDCCH reception, i.e. after the number of PDCCH symbols indicated in the PCFICH. The following condition 704 is used to enter the PDCCH Only Mode 702: in RRC connected mode no DL grant has been received for a number of N_{IdleDL} consecutive subframes (shown in FIG. 7) and there is no pending DL HARQ retransmission (not shown in FIG. 7). Subframes with retransmissions are not counted, e.g. if there are 4 consecutive idle subframes, followed by a subframe with a retransmission and again 2 consecutive idle subframes this is counted as 6 consecutive idle subframes. The parameter N_{IdleDL} is configurable, it may even be adapted dynamically according to the DL traffic profile e.g. depending on the active applications or the traffic history. A typical value for N_{IdleDL} is 10, see more details below with respect to FIG. 9. Other values may be used as well, for example 2, 3, 4, 5, 6, 7, 8, 9, 11, 12, 13, 14, 15, etc.

Once PDCCH Only Mode 702 is active the PDSCH data for the first DL grant will be missed as the RX chain remains switched off in the PDSCH region. As soon as this is detected 703, a NACK is sent to the eNB for the current HARQ process, and the PDCCH Only Mode 702 will be aborted, such that from the next subframe onwards the system again operates in normal mode 701 where the RX chain is kept on after the PDCCH symbols. FIG. 7 illustrates the two modes 701, 702 and the transitions 703, 704 between them.

FIG. 8 is a timing diagram of an LTE subframe 800 illustrating the LTE subframe timing for PDCCH Only Mode 702 according to FIG. 7.

In PDCCH Only Mode 702 as described with respect to FIG. 7 a small throughput impact can be experienced, as an additional retransmission is required for the first DL allocation in PDCCH Only Mode 702 (see details below with respect to FIG. 9), but the advantage is the substantially increased power save impact: Once the condition 704 to enter PDCCH Only Mode 702 is detected, the RX chain is preconfigured to go to power down mode 802 right after the PDCCH region 801 without any internal signaling latency. Assuming again an example configuration of 3 OFDM symbols for the PDCCH 801 the power can be switched off already after about 215 us, thus leaving about 685 us of power down time 802 which is ˜69% of the subframe 800 in power down. Only about 100 us may be reserved for enabling the receiver chain 803 again. For details see the timing diagram in FIG. 8.

The advantage of methods 200, 300 and devices 400 according to the disclosure over known solutions is the substantially higher power saving in low throughput scenarios due to the possibility to switch off the entire RX chain for a much longer time: about 69% of the subframe 800 in power down 802 for PDCCH Only Mode 702 compared to only about 15% in power down 603 for dynamic switching (see details above with respect to FIG. 6). Thus with the timing assumptions above a UE in PDCCH Only Mode 702 will have about 64% less active time for the DL RX chain

FIG. 9 is an exemplary timing diagram 900 illustrating the switching between Normal Mode 701 and PDCCH Only Mode 702 according to FIG. 7 with an exemplary value of N_{idleDL}=4.

As soon as N_{IdleDL} consecutive subframes without DL allocation are detected and there is no pending DL HARQ retransmission PDCCH Only Mode 702 is entered. In the example N_{IdleDL}=4 is assumed, thus PDCCH Only Mode 702 is activated in subframe 5, after the 4 idle subframes 1-4. In PDCCH Only Mode 702 just the PDCCH 901 is monitored and the RX chain is always turned off 902 right after the PDCCH region 901. As soon as a DL grant is decoded 703 the transition back to normal mode 701 is triggered, which is active again from the next subframe onwards. In the example of FIG. 9 there is a DL allocation in subframe 9, which triggers a transition back to normal mode 701 in subframe 10.

As already mentioned above there is a small throughput impact due to the fact that the PDSCH data 902 in the first subframe with a DL grant in PDCCH Only Mode 702 will be missed, and thus an additional retransmission will happen. In the example of FIG. 9 this is the case in subframe 9, which triggers transmission of a NACK in subframe 13 followed by a retransmission in subframe 17. Right after subframe 17 PDCCH Only Mode 702 is activated again, as there were already more than 4 idle subframes (12-16).

Due to the DL inactivity counter N_{IdleDL} the feature only kicks in for low to medium throughput use cases, so it will not affect any high throughput use cases—as for high throughput there will be DL allocations in almost every subframe, and PDCCH Only Mode 702 will not be activated. But due to the bursty nature of LTE data communication even in low to medium throughput use cases the impact will be only a neglectible throughput drop at the beginning of a burst. The exact throughput impact depends on DL traffic profile and eNB scheduling algorithm.

A very beneficial application of the methods 200, 300 and devices 400 according to the disclosure are DL CA (carrier aggregation) use cases: during field testing it has been observed that LTE networks often activate an Scell (secondary cell) but do not immediately schedule data on it. So it can happen that two or more receive paths are active without receiving any user data. This can easily be optimized with methods 200, 300 and devices 400 according to the disclosure by maintaining the count of unscheduled subframes N_{IdleDL} independently per carrier, and thus deciding about switching to PDCCH Only Mode 702 individually per carrier.

Even though methods 200, 300 and devices 400 according to the disclosure have the highest benefits in RRC connected mode with low throughput and without DRX configured, they can also be applied to further optimize the power consumption in connected mode DRX (CDRX): If the on duration is longer than N_{IdleDL}, PDCCH Only Mode 702 will additionally reduce the power consumption during the on duration in CDRX. PDCCH Only Mode 702 can be activated right after the on duration (during the runtime of the inactivity timer), even without waiting for N_{IdleDL} subframes without DL data, as the likelihood for a DL allocation during the runtime of the inactivity timer is very low. This will also further reduce the power consumption in CDRX, in particular as the inactivity timer can be configured with an expiration time of up to 2560 subframes (2,56 s).

FIG. 10 is an exemplary performance diagram 1000 illustrating throughput impact of PDCCH Only Mode when using a simple traffic model. The upper curve 1001 shows fraction of maximum throughput in percent for full DL HARQ transmission mode. The lower curve 1002 shows fraction of maximum throughput in percent for reduced DL HARQ transmission mode. The middle curves 1003 show fraction of maximum throughput in percent for PDSCH throughput with different thresholds ranging from N_{IdleDL}=1 to 40 subframes.

Simulation results for a simple DL traffic profile are provided in FIG. 10 which give an upper bound for the throughput impact depending on the chosen setting of N_{IdleDL}. The underlying model allocates DL data based on a simple statistic and always discards the data for the first DL HARQ transmission in PDCCH Only Mode 702. The impact against a real eNB will be much smaller, as it will schedule the retransmissions independently of new transmissions. But still the model gives a good indication on the initial dimensioning of N_{IdleDL}: a value of 10 provides a good balance between power saving and throughput impact: ˜50% of the time in PDCCH Only Mode with maximum ˜10% throughput degradation.

FIG. 11 is an exemplary performance diagram 1100 illustrating PDCCH decoding performance with channel estimation on different number of CRS symbols. The first curve 1101 illustrates PDCCH decoding performance with channel estimation on one CRS symbol at 0(n). The second curve 1102 illustrates PDCCH decoding performance with channel estimation on two CRS symbols at 0(n), 4(n). The third curve 1103 illustrates PDCCH decoding performance with channel estimation on three CRS symbols at 7(n-1), 11(n-1), 0(n). The fourth curve 1104 illustrates PDCCH decoding performance with channel estimation on four CRS symbols at 7(n-1), 11(n-1), 0(n), 4(n).

A further application of PDCCH Only Mode 702 is in low SNR use cases, e.g. in cell edge scenarios. The Common Reference Signal (CRS) required to demodulate the PDCCH is broadcast in OFDM symbols #0 and #4. In good SNR conditions the CRS in symbol #0 is sufficient to successfully demodulate the PDCCH. But in bad SNR the additional CRS in symbol #4 is required to achieve the full demodulation performance, see simulation results in FIG. 11.

FIG. 12 is an exemplary timing diagram 1200 illustrating dynamic switching of the RX chain with two CRS symbols for PDCCH channel estimation according to a conventional LTE standard, i.e. a switching without using a method 200, 300 or a device 400 described above with respect to FIGS. 2 to 4. FIG. 12 thus corresponds to FIG. 6 in the case of using two CRS symbols for PDCCH channel estimation.

With the timing example depicted in FIG. 12, dynamic switching of the RX chain depending on the PDCCH decoding result is no longer possible, if demodulation is only started after symbol #4, as the two additional symbols (equivalent to ˜143 us) almost completely eat up the remaining power down gap 1204. For details see FIG. 12.

FIG. 13 is an exemplary timing diagram 1300 for PDCCH Only Mode with two CRS symbols for PDCCH channel estimation.

When using a method 200, 300 or a device 400 according to the disclosure, i.e. using PDCCH Only Mode 702 still a significant gap 1302 of about 540 us remains, see FIG. 13.

So PDCCH Only Mode 702 is still applicable even in low SNR use cases as e.g. in cell edge scenarios. The power saving is a bit lower as in good SNR due to the additional 2 symbols during which the RX chain has to be kept on, but still it is possible to shut down the RX chain in more than 50% of the subframe. From implementation perspective the two scenarios should be treated separately: in good SNR conditions (e.g. with SNR headroom of more than 3 dB) the RX chain is switched off already after the last symbol carrying the PDCCH (i.e. after the number of symbols indicated in the PCFICH), while in bad SNR conditions (e.g. with SNR headroom of less than 3 dB) the RX chain is only switched off after symbol #4, which still allows a substantial power save compared to always on (up to ˜50%).

There is even additional power saving potential when PDCCH Only Mode 702 is combined with dynamic Rx diversity: The basic idea of dynamic Rx diversity is to use only a single receive antenna in non-MIMO use cases (i.e. for transmission modes 1 and 2), as long as the SNR is good enough, and to dynamically switch back to RX diversity as soon as the SNR degrades. If PDCCH Only Mode 702 is used in combination with dynamic RX diversity additional power saving in non-MIMO use cases with good SNR can be achieved and some of the decision logic can be shared between both features.

Methods and devices according to the disclosure are applicable for extended cyclic prefix and TDD configurations as well, only the detailed timings will be different to the examples shown above.

Methods and devices according to the disclosure allow to significantly reduce the power consumption in LTE connected mode with low throughput. Power consumption is one of the most important KPIs for cellular modems, as it directly impacts battery lifetime and thus user experience. The main benefit of methods and devices according to the disclosure can be seen in the following use cases: standby with background traffic, chat, web browsing, internet radio, VoIP etc. for both good and bad SNR conditions. As methods and devices according to the disclosure are beyond the behavior specified by 3GPP they allow to build differentiated products with an improved user experience: longer battery lifetime for the use cases listed above.

### EXAMPLES

The following examples pertain to further embodiments. Example 1 is a method for power saving in a radio receiver receiving a sequence of radio subframes, the method comprising: monitoring information from at least one first section of at least one radio subframe in the sequence of radio subframes; and if the information indicates an absence of user data in at least one second section of a threshold number of successive sequence of radio subframes, changing to a first state in which receiving of the at least one second section is switched-off.

In Example 2, the subject matter of Example 1 can optionally include monitoring information from the at least one first section of a given radio subframe in the sequence of radio subframes and received after the at least one radio subframe; if the monitored information indicates a presence of user data in the at least one second section of the given radio subframe, changing from the first state to a second state in which receiving of the at least one second section of the sequence of radio subframes is activated.

In Example 3, the subject matter of Example 1 or Example 2 can optionally include that the at least one first section and the at least one second section are successively arranged in each radio subframe.

In Example 4, the subject matter of any one of Examples 1-3 can optionally include that in the second state receiving of the at least one first section of the sequence of radio subframes is turned-on to monitor information indicating a presence of user data in the corresponding at least one second section.

In Example 5, the subject matter of any one of Examples 1-4 can optionally include that in the first state receiving of the at least one second section of the sequence of radio subframes is turned-off.

In Example 6, the subject matter of any one of Examples 1-5 can optionally include changing from the second state to the first state if no retransmission of a radio subframe is pending.

In Example 7, the subject matter of Example 6 can optionally include delaying the changing to the first state depending on a number of pending retransmissions of the sequence of radio subframes.

In Example 8, the subject matter of Examples 2 can optionally include reporting a failed reception of the given radio subframe which at least one first section caused a change from the first state to the second state.

In Example 9, the subject matter of Example 8 can optionally include initiating a retransmission of the given radio subframe which at least one first section caused a change from the first state to the second state.

Example 10 is a method for power saving in an LTE radio receiver receiving a sequence of LTE subframes, the method comprising: monitoring successive first sections of the sequence of LTE subframes for DL grant information; detecting that no DL grant information is in a threshold number of successive first sections of the sequence of LTE subframes; and in response to detecting that no DL grant information is in the threshold number of successive first sections of the sequence of LTE subframes, turning off the receiving of second sections of the sequence of LTE subframes.

In Example 11, the subject matter of Example 10 can optionally include that each LTE subframe comprises a first section of PDCCH OFDM symbols followed by a corresponding second section of PDSCH OFDM symbols.

In Example 12, the subject matter of Example 10 or 11 can optionally include monitoring the first sections of the sequence of LTE subframes for DL grant information while the receiving of the second sections of the sequence of LTE subframes is turned off; detecting DL grant information in the first section of a given LTE subframe; and in response to detecting DL grant information in the first second of the given LTE subframe, turning on the receiving of the second sections of the sequence of LTE subframes.

In Example 13, the subject matter of Example 12 can optionally include turning-off the receiving of the second sections of the sequence of LTE subframes if no retransmission of an LTE subframe is pending.

In Example 14, the subject matter of Example 12 or 13 can optionally include delaying the turning-off of the receiving depending on a number of pending HARQ retransmissions of LTE subframes.

In Example 15, the subject matter of any one of Examples 10-14 can optionally include reporting a failed reception of the given LTE subframe.

In Example 16, the subject matter of any one of Examples 10-15 can optionally include initiating a retransmission of the given LTE subframe.

Example 17 is a power saving circuit for a mobile device, the power saving circuit comprising: a monitoring circuit for monitoring a received sequence of LTE subframes, wherein each LTE subframe comprises a first section of PDCCH OFDM symbols followed by a corresponding second section of PDSCH OFDM symbols, wherein the monitoring circuit is configured to monitor a number of successive first sections of the received sequence of LTE subframes for DL grant information; and a signaling circuit configured to signal a receive path to turn-off receiving the second sections of the sequence of LTE subframes if no DL grant information is detected in the number of successive first sections of the sequence of LTE subframes.

In Example 18, the subject matter of Example 17 can optionally include that the monitoring circuit is configured to monitor the first sections of the sequence of LTE subframes for DL grant information when the receiving of the second sections of the sequence of LTE subframes is turned-off in the receive path; and that the signaling circuit is configured to signal the receive path to turn-on receiving the second sections of the sequence of LTE subframes if the DL grant information is detected in a first section of the sequence of LTE subframes.

In Example 19, the subject matter of any one of Examples 17-18 can optionally include that the signaling circuit is configured to signal the receive path to turn-off receiving the second sections of the sequence of LTE subframes when the mobile device is in Radio Resource Control Connected mode.

In Example 20, the subject matter of any one of Examples 17-18 can optionally include that the signaling circuit is configured to signal the receive path to turn-off receiving the second sections of the sequence of LTE subframes when the mobile device is in Connected Mode Discontinuous Receive.

In Example 21, the subject matter of any one of Examples 17-20 can optionally include that the mobile device is connected to a primary cell based on a first carrier and to one or more secondary cells based on one or more secondary carriers; and that the signaling circuit is configured to signal the receive path to turn-off receiving the second sections of the sequence of LTE subframes carrier-independently.

In Example 22, the subject matter of any one of Examples 17-21 can optionally include that the mobile device comprises an RX diversity receiver comprising the receive path and a second receive path; and that the signaling circuit is configured to signal the receive path to turn-off receiving the second sections of the sequence of LTE subframes depending on information indicating an activity of the second receive path.

Example 23 is a power saving circuit for a mobile device, the power saving circuit comprising: a monitoring circuit for monitoring a received sequence of LTE subframes, wherein each LTE subframe comprises a first section of PDCCH OFDM symbols followed by a corresponding second section of PDSCH OFDM symbols, wherein the monitoring circuit is configured to monitor a number of successive first sections of the received sequence of LTE subframes for DL grant information; and a signaling circuit configured to signal a receive path to turn-off receiving the second sections of the sequence of LTE subframes if no DL grant information is detected in the number of successive first sections of the sequence of LTE subframes, wherein the turn-off is responsive to a detection of a cell-specific reference symbol in the second section after the DL grant information in the number of successive first sections.

In Example 24, the subject matter of Example 23 can optionally include that the signaling circuit is configured to use the first condition or the second condition depending on a signal-to-interference and noise ratio.

Example 25 is a computer readable medium on which computer instructions are stored which when executed by a computer, cause the computer to perform the method of one of Examples 1 to 17.

Example 26 is a device for power saving in a radio receiver receiving a sequence of radio subframes, wherein each radio subframe comprises a first section carrying control data and a successively arranged second section, the device comprising: means for monitoring information from a number of successive first sections of the sequence of radio subframes; and means for changing from a first state in which the receiving of the second section of the sequence of radio subframes is activated to a second state in which the receiving of the second section of the sequence of radio subframes is switched-off, if the monitored information indicates an absence of user data in the corresponding second sections, wherein the changing is based on a transition from the first section to the second section of the sequence of radio subframes.

In Example 27, the subject matter of Example 26 can optionally include means for changing from the second state to the first state if information monitored from a first section of the sequence of radio subframes indicates a presence of user data in the corresponding second section.

In Example 28, the subject matter of Example 27 can optionally include means for changing from the first state to the second state or vice versa when receiving the next radio subframe after the information indicating the absence or the presence of user data is monitored.

In Example 29, the subject matter of any one of Examples 26-28 can optionally include means for changing from the first state to the second state if in each first section of the number of successive first sections the monitored information indicates an absence of user data in the corresponding second sections.

In Example 30, the subject matter of any one of Examples 25-29 can optionally include means for changing from the second state to the first state if in a single first section of the sequence of radio subframes information is monitored indicating a presence of user data in the corresponding second section.

Example 31 is a power saving system for a mobile device, the power saving system comprising: a monitoring device for monitoring a received sequence of LTE subframes, wherein each LTE subframe comprises a first section of PDCCH OFDM symbols followed by a corresponding second section of PDSCH OFDM symbols, wherein the monitoring device is configured to monitor a number of successive first sections of the received sequence of LTE subframes for DL grant information; and a signaling device configured to signal a receive path to turn-off receiving the second sections of the sequence of LTE subframes if no DL grant information is detected in the number of successive first sections of the sequence of LTE subframes, wherein the turn-off is responsive to a transition from a first section to a corresponding second section of the sequence of LTE subframes.

In Example 32, the subject matter of Example 31 can optionally include that the monitoring device is configured to monitor the first sections of the sequence of LTE subframes for DL grant information when the receiving of the second sections of the sequence of LTE subframes is turned-off in the receive path; and that the signaling device is configured to signal the receive path to turn-on receiving the second sections of the sequence of LTE subframes if the DL grant information is detected in a first section of the sequence of LTE subframes.

In Example 33, the subject matter of any one of Examples 31-32 can optionally include that the signaling device is configured to signal the receive path to turn-off receiving the second sections of the sequence of LTE subframes when the mobile device is in Radio Resource Control Connected mode.

In Example 34, the subject matter of any one of Examples 31-33 can optionally include that the system is an on-chip system.

In addition, while a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it is understood that aspects of the disclosure may be implemented in discrete circuits, partially integrated circuits or fully integrated circuits or programming means. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1. A method for power saving in a radio receiver receiving a sequence of radio subframes, the method comprising:
monitoring information from at least one first section of at least one radio subframe in the sequence of radio subframes; and
if the information indicates an absence of user data in at least one second section of a threshold number of successive sequence of radio subframes, changing to a first state in which receiving of the at least one second section is switched-off.

2. The method of claim 1, comprising:
monitoring information from the at least one first section of a given radio subframe in the sequence of radio subframes and received after the at least one radio subframe;
if the monitored information indicates a presence of user data in the at least one second section of the given radio subframe, changing from the first state to a second state in which receiving of the at least one second section of the sequence of radio subframes is activated.

3. The method of claim 1,
wherein the at least one first section and the at least one second section are successively arranged in each radio subframe.

4. The method of claim 1,
wherein in the second state receiving of the at least one first section of the sequence of radio subframes is turned-on to monitor information indicating a presence of user data in the corresponding at least one second section.

5. The method of claim 1,
wherein in the first state receiving of the at least one second section of the sequence of radio subframes is turned-off.

6. The method of claim 1, comprising:
changing from the second state to the first state if no retransmission of a radio subframe is pending.

7. The method of claim 6, comprising:
delaying the changing to the first state depending on a number of pending retransmissions of the sequence of radio subframes.

8. The method of claim 2, comprising:
reporting a failed reception of the given radio subframe which at least one first section caused a change from the first state to the second state.

9. The method of claim 8, comprising:
initiating a retransmission of the given radio subframe which at least one first section caused a change from the first state to the second state.

10. A method for power saving in an LTE radio receiver receiving a sequence of LTE subframes, the method comprising:
monitoring successive first sections of the sequence of LTE subframes for DL grant information;
detecting that no DL grant information is in a threshold number of successive first sections of the sequence of LTE subframes; and
in response to detecting that no DL grant information is in the threshold number of successive first sections of the sequence of LTE subframes, turning off the receiving of second sections of the sequence of LTE subframes.

11. The method of claim 10,
wherein each LTE subframe comprises a first section of PDCCH OFDM symbols followed by a corresponding second section of PDSCH OFDM symbols.

12. The method of claim 10, comprising:
monitoring the first sections of the sequence of LTE subframes for DL grant information while the receiving of the second sections of the sequence of LTE subframes is turned off;
detecting DL grant information in the first section of a given LTE subframe; and
in response to detecting DL grant information in the first second of the given LTE subframe, turning on the receiving of the second sections of the sequence of LTE subframes.

13. The method of claim 12, comprising
turning-off the receiving of the second sections of the sequence of LTE subframes if no retransmission of an LTE subframe is pending.

14. The method of claim 12, comprising:
delaying the turning-off of the receiving depending on a number of pending HARQ retransmissions of LTE subframes.

15. The method of claim 12, comprising:
reporting a failed reception of the given LTE subframe.

16. The method of claim 15, comprising:
initiating a retransmission of the given LTE subframe.

17. A power saving circuit for a mobile device, the power saving circuit comprising:
a monitoring circuit for monitoring a received sequence of LTE subframes, wherein each LTE subframe comprises a first section of PDCCH OFDM symbols followed by a corresponding second section of PDSCH OFDM symbols, wherein the monitoring circuit is configured to monitor a number of successive first sections of the received sequence of LTE subframes for DL grant information; and
a signaling circuit configured to signal a receive path to turn-off receiving the second sections of the sequence of LTE subframes if no DL grant information is detected in the number of successive first sections of the sequence of LTE subframes.

18. The power saving circuit of claim 17,
wherein the monitoring circuit is configured to monitor the first sections of the sequence of LTE subframes for DL grant information when the receiving of the second sections of the sequence of LTE subframes is turned-off in the receive path; and
wherein the signaling circuit is configured to signal the receive path to turn-on receiving the second sections of the sequence of LTE subframes if the DL grant information is detected in a first section of the sequence of LTE subframes.

19. The power saving circuit of claim 17,
wherein the signaling circuit is configured to signal the receive path to turn-off receiving the second sections of the sequence of LTE subframes when the mobile device is in Radio Resource Control Connected mode.

20. The power saving circuit of claim 17,
wherein the signaling circuit is configured to signal the receive path to turn-off receiving the second sections of the sequence of LTE subframes when the mobile device is in Connected Mode Discontinuous Receive.

21. The power saving circuit of claim 17,
wherein the mobile device is connected to a primary cell based on a first carrier and to one or more secondary cells based on one or more secondary carriers; and
wherein the signaling circuit is configured to signal the receive path to turn-off receiving the second sections of the sequence of LTE subframes carrier-independently.

22. The power saving circuit of claim 17,
wherein the mobile device comprises an RX diversity receiver comprising the receive path and a second receive path; and
wherein the signaling circuit is configured to signal the receive path to turn-off receiving the second sections of the sequence of LTE subframes depending on information indicating an activity of the second receive path.

23. Power saving circuit for a mobile device, the power saving circuit comprising:
a monitoring circuit for monitoring a received sequence of LTE subframes, wherein each LTE subframe comprises a first section of PDCCH OFDM symbols followed by a corresponding second section of PDSCH OFDM symbols, wherein the monitoring circuit is configured to monitor a number of successive first sections of the received sequence of LTE subframes for DL grant information; and
a signaling circuit configured to signal a receive path to turn-off receiving the second sections of the sequence of LTE subframes if no DL grant information is detected in the number of successive first sections of the sequence of LTE subframes,
wherein the turn-off is responsive to a detection of a cell-specific reference symbol in the second section of the sequence of LTE subframes.

24. The power saving circuit of claim 23,
wherein the signaling circuit is configured to turn-off the receiving of the second sections depending on a signal-to-interference and noise ratio.
